(19) United States
(12) Patent Application Publication
(10) Pub. No.: US 2014/0200033 A1
(43) Pub. Date: Jul. 17, 2014

(54) Controlling Device Functionality Based On Device Location And Calendar Information

(71) Applicant: ALMINDER, INC., Palo Alto, CA (US)

(72) Inventors: Max WHEELER, Palo Alto, CA (US); Scott PUTTERMAN, Palo Alto, CA (US); Tony ROBINSON, Palo Alto, CA (US); Sapna SAWHNEY, Palo Alto, CA (US); William KLINE, Palo Alto, CA (US)

(73) Assignee: ALMINDER, INC., Palo Alto, CA (US)

(21) Appl. No.: 14/055,362

(22) Filed: Oct. 16, 2013

Related U.S. Application Data
(60) Provisional application No. 61/715,127, filed on Oct. 17, 2012.

(51) Int. Cl. H04W 4/02

(52) U.S. Cl. CPC H04W 4/028
USPC 455/456.3

(57) ABSTRACT

Embodiments are provided by an application executing on a processor, the embodiments comprising determining a current location of a mobile device hosting the application. A determination is made using a calendar of the mobile device an event and a start time of the event. A location of the event is determined. Travel parameters are used to predict a travel time to the location. An alert is generated and presented based on the predicted travel time, wherein the alert is an alert for when to start travel to the location.

### RELATED APPLICATION

This application claims the benefit of U.S. Patent Application No. 61/715,127, filed Oct. 17, 2012.

### TECHNICAL FIELD

The embodiments described herein relate to applications running on a processor and, more particularly, an application for providing functions on a smart phone or other portable computing device.

### BACKGROUND

There is a need for device applications that provide additional functionality around calendar events and techniques for managing events of the calendar.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a flow diagram for operations of the Mynd application, under an embodiment.

FIG. 2 shows a prediction table of the Mynd application, under an embodiment.

### DETAILED DESCRIPTION

Embodiments described herein include an application or component running on a processor of an electronic device, for example a smart phone, tablet computer, or other personal mobile or computing device. The application of an embodiment, also referred to herein as the “Mynd Calendar,” is a context-aware application that uses the one or more of the calendar and host device (e.g., iPhone, etc.) location to provide one or more functions that include, but are not limited to, the following: time to leave notifications for events; running Late notifications; user interface (UI) for managing event location origins and destinations; UI for detecting event attendee contact information and allowing quick access to the information; UI for showing travel time and traffic to events for the next week; algorithm for predicting future locations (Smart Locations) based on past location activity and providing travel information to those locations when the user is predicted to be there (Smart Events).

In the following description, numerous specific details are introduced to provide a thorough understanding of, and enabling description for, the systems and methods described. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

The Mynd Calendar application, or app, of an embodiment includes one or more UI or presentations that provide information of the app to a user of the host device. As an example, a UI presents one or more pages or screens of information that includes but is not limited to a current date and time, a current location, information of one or more events on a calendar, alerts corresponding to the events, location of the events, distance to a location of the events, drive time to the location of the events, route to the location of the events from a current location, notes corresponding to one or more of the event or people associated with the event, list of attendees for events, profile information for the attendees, and contact information for the attendees.

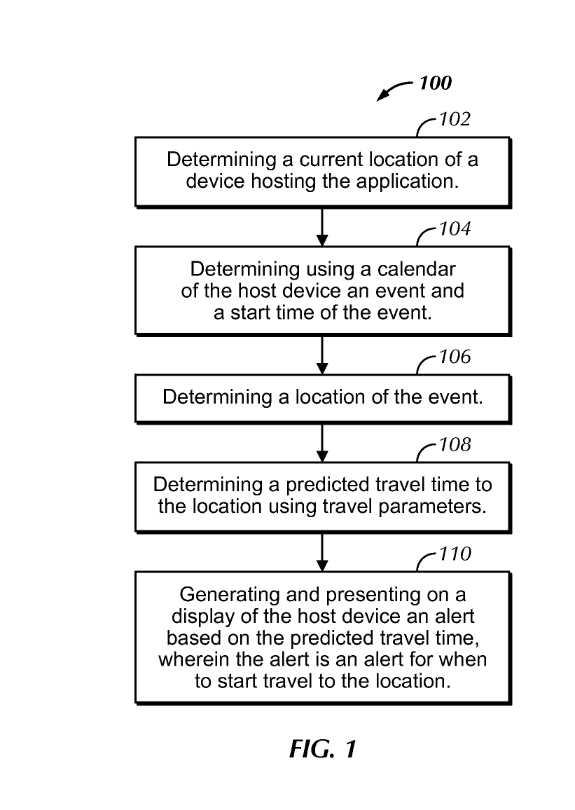

As an example, FIG. 1 is a flow diagram for operations 100 of the Mynd application, under an embodiment. Generally, the Mynd. Calendar application determines a current location of a mobile device hosting the application 102. The application determines, using a calendar of the mobile device, an event and a start time of the event 104. The application also determines a location of the event 106. The application determines a predicted travel time to the location using travel parameters 108, and generates and presents via the host device an alert based on the predicted travel time 110. The travel parameters include but are not limited to one or more of traffic condition information, travel speed, and environment type to name a few. The alert is an alert for a recommended time to start travel to the location. The application of an embodiment launches a navigation application at departure in order to assist a user in navigating to the location of the event.

The application also determines information pertaining to subsequent events beyond the next event. For example, the application determines using the calendar a next event and a next start time of the next event. The application determines a location of the next event along with a predicted travel time to the location. The application generates and presents via the host device an alert corresponding to the predicted travel time to this next event.

The application of an embodiment uses information of the calendar or other applications on the host device to identify at least one person associated with the event. Furthermore, the application retrieves data of the person from at least one of contacts included on the mobile device and a social networking application remote to the mobile device.

Mynd application operations include monitoring the current location of the host device. The monitoring includes making a determination as to when the current location changes to a visited location that is different from the current location, and determining a position of each visited location by generating a first position type of the visited location that is a relatively low-accuracy position type. The application maintains the visited location along with any other visited locations in a location list. The Mynd application of an embodiment compares the visited locations with calendar information of the calendar, and generates at least one association between the visited locations and a term used to identify a calendar event that corresponds to the visited locations.

The application identifies Smart Locations among the visited locations on the location list. Smart Locations include locations visited by the host device some number of times, where the number of visits exceeds a pre-specified threshold, but are not so limited. The application determines a second position type for the Smart Location, and the second position type is a relatively high-accuracy position. For example, the second position type of an embodiment is a Global Positioning System (GPS) position. Furthermore, a street address of the Smart Location is determined in an embodiment. For Smart Locations, the application determines if the location is a designated location that includes at least one of a home location and a work location.

The identification of Smart Locations involves generating or maintaining a mapping of a day and/or time the host device is detected at each Smart Location. The application generates a prediction table that includes for each smart location at least one probability of the host device being at the corresponding Smart Location. The prediction table comprises a list days and numerous time segments for each day, and includes a probability corresponding to each of the numerous time segments. Additionally, generation of the prediction table involves identifying for each time segment the Smart Location having a highest probability of being visited. Generation of the prediction table of an embodiment also includes modification of the prediction table to include calendar information of a calendar application.

The application modifies the prediction table for each Smart Location using visit parameters that include at least one of a last day visited, a last time visited, a total number of visits, and consistency data of visits. The modification of an embodiment also includes revision of a first prediction based a time and/or location of a subsequent prediction, wherein a time segment of the first prediction is adjacent to a time segment of the subsequent prediction.

More specifically, the Mynd application of an embodiment includes origin detection functionality. When approaching the start time for a given event, the application uses information or data of the current location from the smart phone to determine travel time and traffic. In so doing, the application determines the origins for future events and generates and provides predicted drive times to those events.

For example if a user has a meeting next Tuesday at 3 PM in San Jose, Calif. and a meeting that same day at 4 PM in Santa Clara, Calif., then it's likely that the origin for the Santa Clara meeting is the location of the 3 PM meeting in San Jose. In order to determine a given event's origin the application of an embodiment compares current location, previous event and Smart Event, and generates certain quick assessments about predicted drive times from each location above to the destination event. The quick assessment comprises determining or finding the distance between a prospective origin and the event destination and then calculating a drive time assuming the user would average a pre-specified speed in a straight line. The assumed average speed of an embodiment is 45 miles per hour, but the embodiment is not so limited and could be any speed appropriate to the other data used in the determination (e.g., traffic conditions, type of environment, etc.). This estimate is referred to as the “Crow Time” as it is derived from the use of a straight line from origin to destination.

The application then determines whether there is enough time or too much time to drive from each of the origins to the destination. Also, a determination is made as to whether the user would be more likely to drive back to the Smart Event before going from one calendar event to another calendar event. In so doing, the application makes one or more assumptions that include, but are not limited to, the following: do not use the previous event or current location if three-quarters of the Crow Time is beyond the start of the event; use the previous event or current location if the Crow Time is very close (e.g., within 10% of the Crow Time, etc.) to the start of the event; if the previous event or current location is more than a specified number (e.g., four (4), etc.) multiplied by the Crow Time, or a specified number of hours (e.g., four (4), etc.) away from the event, whichever is greater, then neither is considered as a prospective origin; if there is a Smart Event before the event and if the Crow Time of that event is within range and there is no other prospective origin then use the Smart Event as the origin; if there is a valid origin and there is a valid Smart Event, then choose the one that is closest in time to the destination event.

The Mynd application of an embodiment includes functionality referred to herein as Smart Locations and Smart Events, each of which is described herein in detail. The Smart Locations functionality of the Mynd application of an embodiment continually monitors the user's location in a battery-friendly manner and attempts to determine locations that the user visits frequently. The battery friendly manner uses a low-power feature of the host device operating system (OS) (e.g., iOS, etc.) that provides an indication as to a significant location change. This involves cell tower triangulation and other non-GPS means of location determination, for example, but is not so limited. While efficiently managing battery usage this technique provides a low accuracy fix on the user's location where accuracy can be as low as a kilometer or more, for example, but is not so limited.

The Mynd application keeps track of the low-resolution locations until it determines there is a good chance that a given location is frequently visited. This is true when the duration of a visit to a location is greater than a pre-specified period of time (e.g., one (1) hour, etc.) or when a number of independent visits to the location exceed a pre-specified number (e.g., seven (7), etc.). The application then requests a high-resolution GPS fix the next time the device is near that location. Once the GPS location is determined, the application reverse-geocodes that location and provides to the user a friendly street address. If the location is further determined to match the characteristics of a Home or Work location it is appropriately labeled as such. The Mynd application also automatically uses the labels “Home” and “Work” in the location field of calendar events to refer to these discovered Smart Location addresses.

As described above, the Mynd application of an embodiment includes Smart Events functionality. A component in discovering Smart Locations involves maintaining a map of particular hours and days of the week that a user is visiting each particular location. The application maintains a prediction table for each smart location, and the prediction table includes entries for each day of the week indicating the likelihood (e.g., percentage) of a user visiting that location at a particular time, divided into increments of a pre-specified duration (e.g., 15 minute increments, etc.).

An embodiment computes Smart Events by determining, for each increment (e.g., 15-minute increment, etc.) of each day of the week, the Smart Location with the highest likelihood of being visited. There are modifications made to each Smart Location's prediction table based on such factors as last time visited, total number of visits and consistency of visits, to name a few. This results in a single prediction table for all Smart Locations.

Using an increment with a 15-minute duration as an example, the prediction percentage for the 15-minute interval for a given Smart Location is calculated by looking at that same 15-minute interval or period for every week for which data is available for the Location. Then the percentage chance of the user visiting that Location at that time again in the future is calculated as number of visits/number_of_possible_visits, but is not so limited as other methods of calculation may be available in alternative embodiments.

An embodiment uses positive and negative modifiers to enhance the chances that good Locations are identified. Locations having more visits and at which greater amounts of time are spent have a positive modifier and, conversely, Locations having infrequent or short-term visits have a negative modifier. For example, if an embodiment includes 4 weeks of data for a Location and the user was at that Location on a Monday at 9:15 AM for three (3) of those four weeks, but was not at that Location on the remaining Monday at 9:15 AM, then the prediction for the use to be at that spot on a future Monday at 9:15 AM would be three divided by four, or 75 percent.

Computation of Smart Events continues by again looking at the 15-minute intervals. For a given interval the application evaluates all the Smart Locations that had visits at a particular time and determines which, if any, are the most probable. The highest non-zero value becomes the assumption of the user's location for that time period. The prediction percentage for each Smart Location is reduced in a reverse exponential fashion based on how long it has been since it was last visited during this interval. This is done in order to prefer more recently visited locations over ones that have not been visited in some time. Visits having an age less than a pre-specified period of time (e.g., one week old, etc.) are not reduced.

The prediction table is organized in contiguous segments indicating the belief that the user is likely to be at that location at the time range indicated. An embodiment performs manipulations of this computed range to throw away obviously inaccurate data such as impossible drive times.

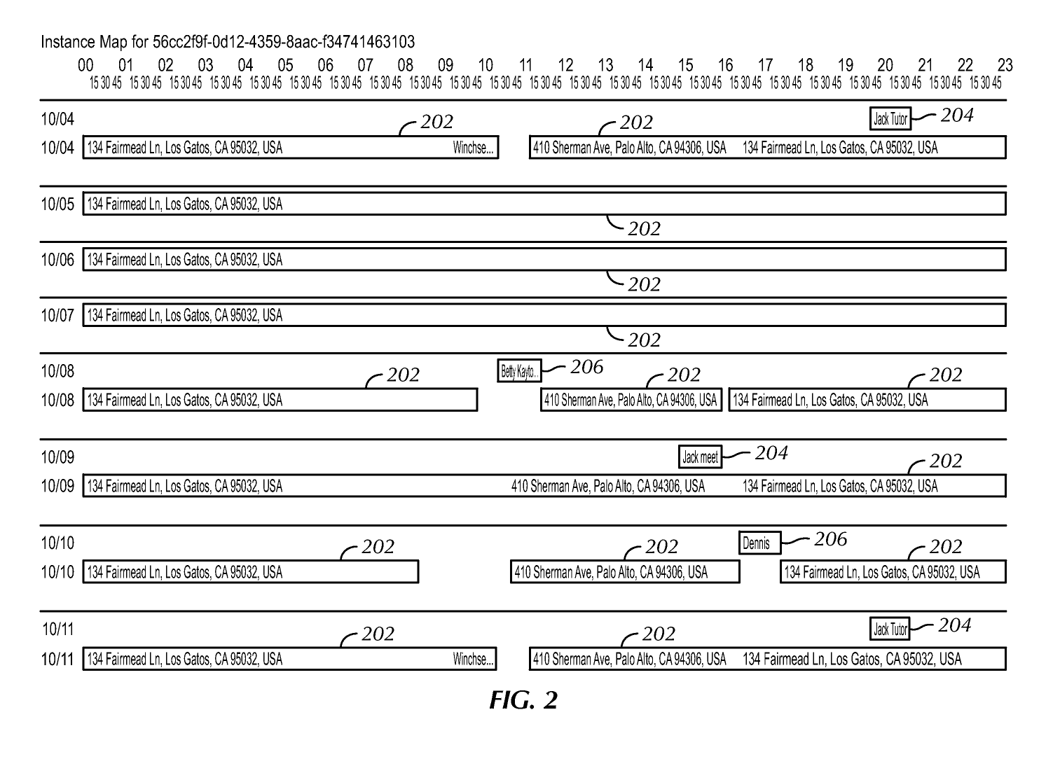

The user's calendar events are then used to chop out holes in the prediction table where it is known that the user will not be at the Smart Locations. FIG. 2 shows a prediction table, under an embodiment. A first type of indicator 202 (e.g., blue line) indicates predicted Smart Events. A second type of indicator 204 (e.g., yellow line) indicates calendar events with no known location. A third type of indicator 206 (e.g., orange line) indicates calendar events with a known location. In this manner the Smart Events can be used as potential origins for future events.

Smart Events of an embodiment is used to geocode user labels for locations. Many users use keywords in the calendar location field that make sense only to themselves. For example, users may use terms such as “Mom's Place” or “Soccer” to indicate a location known to them. It is not possible to geocode these locations in the traditional ways. However, through use of the user's predicted location and matching that location with calendar events, the Mynd application learns to associate these labels with real locations over time. Then, the application is able to provide the user with drive time and traffic information in advance of visiting these locations.

Embodiments described herein include a method provided by an application executing on a processor. The method comprises determining a current location of a mobile device hosting the application. The method comprises determining using a calendar of the mobile device an event and a start time of the event. The method comprises determining a location of the event. The method comprises determining a predicted travel time to the location using travel parameters. The method comprises generating and presenting on a display of the mobile device an alert based on the predicted travel time. The alert is an alert for when to start travel to the location.

Embodiments described herein include a method provided by an application executing on a processor, the method comprising: determining a current location of a mobile device hosting the application; determining using a calendar of the mobile device an event and a start time of the event; determining a location of the event; determining a predicted travel time to the location using travel parameters; and generating and presenting on a display of the mobile device an alert based on the predicted travel time, wherein the alert is an alert for when to start travel to the location.

The method comprises determining using the calendar a second event and a second start time of the second event. The second event follows the first event. The method comprises determining a second location of the second event. The method comprises determining a second predicted travel time to the second location using travel parameters. The method comprises generating and presenting on a display of the mobile device a second alert based on the second predicted travel time, wherein the second alert is an alert for when to start travel to the second location.

The method comprises launching a navigation application.

The method comprises providing to the navigation application the current location and at least one of the first location and the second location.

The travel parameters of an embodiment include one or more of traffic condition information, travel speed, environment type.

The method comprises identifying at least one name of a person listed in the event. The method comprises retrieving data of the person from at least one of contacts included on the mobile device and a social networking application remote to the mobile device.

The method comprises monitoring the current location of the mobile device.

The monitoring of an embodiment comprises determining when the current location changes to a visited location that is different from the current location.

The method comprises determining a position of each visited location by generating a first position type of the visited location.

The first position type of an embodiment is a relatively low-accuracy position.

The method comprises maintaining the visited location in a location list, wherein the location list comprises a plurality of visited locations.

The method comprises identifying any smart location among the plurality of visited locations on the location list, wherein a smart location includes a location visited by the mobile device a number of times, wherein the number of times exceeds a threshold.

The method comprises determining the position of the smart location by generating a second position type of the visited location.

The second position type of an embodiment is a relatively high-accuracy position.

The second position type of an embodiment is a Global Positioning System (GPS) position.

The method comprises determining a street address of the smart location.

The method comprises determining if the smart location is a designated location, wherein the designated location includes at least one of a home location and a work location.

The method comprises comparing the plurality of visited locations with calendar information of the calendar. The method comprises generating at least one association between at least one visited location of the plurality of visited locations and a term used to identify a calendar event that corresponds to the at least one visited location.

The identifying of any smart location of an embodiment comprises maintaining a mapping of at least one of a day and a time the mobile device is detected at each smart location.

The method comprises generating a prediction table, wherein the prediction table includes for each smart location at least one probability of the mobile device being at the corresponding smart location.

The prediction table of an embodiment comprises a list days and a plurality of time segments for each day, wherein the prediction table comprises a probability corresponding to each time segment of a plurality of time segments.

The generating of the prediction table of an embodiment comprises identifying for each time segment the smart location having a highest probability.

The generating of the prediction table of an embodiment comprises applying calendar information of the calendar to the prediction table.

The generating of the prediction table of an embodiment comprises modifying the prediction table for each smart location using visit parameters that include at least one of a last day visited, a last time visited, a total number of visits, and consistency data of visits.

The modifying of an embodiment comprises revising a first prediction based on at least one of a time and location of a second prediction, wherein a first time segment of the first prediction is adjacent to a second time segment of the second prediction.

Embodiments described herein include a method provided by an application executing on a processor. The method comprises determining a current location of a mobile device hosting the application. The method comprises determining using a calendar of the mobile device a plurality of events and a plurality of start times corresponding to the plurality of events. The method comprises determining a plurality of locations corresponding to the plurality of events. The method comprises determining a plurality of predicted travel times to each of the plurality of locations using travel parameters. The method comprises generating and presenting on a display of the mobile device a plurality of alerts based on the plurality of predicted travel times. An alert is an alert for when to start travel to the location from the current location corresponding to a time of the alert.

Embodiments described herein include a method provided by an application executing on a processor, the method comprising: determining a current location of a mobile device hosting the application; determining using a calendar of the mobile device a plurality of events and a plurality of start times corresponding to the plurality of events; determining a plurality of locations corresponding to the plurality of events; determining a plurality of predicted travel times to each of the plurality of locations using travel parameters; and generating and presenting on a display of the mobile device a plurality of alerts based on the plurality of predicted travel times, wherein an alert is an alert for when to start travel to the location from the current location corresponding to a time of the alert.

Embodiments described herein include a system comprising an application executing on a processor. The application determines a current location of a device hosting the application. The application determines using a calendar coupled to the device an event and a start time of the event. The application determines a location of the event. The application determines a predicted travel time to the location using travel parameters. The application generates and presents via the device an alert based on the predicted travel time. The alert is an alert for when to start travel to the location.

Embodiments described herein include a system comprising: an application executing on a processor, the application, determining a current location of a device hosting the application; determining using a calendar coupled to the device an event and a start time of the event; determining a location of the event; determining a predicted travel time to the location using travel parameters; and generating and presenting via the device an alert based on the predicted travel time, wherein the alert is an alert for when to start travel to the location.

The travel parameters of an embodiment include one or more of traffic condition information, travel speed, environment type.

The application of an embodiment identifies at least one name of a person listed in the event. The application retrieves data of the person from at least one of contacts included on the device and a social networking application remote to the device.

The application of an embodiment monitors the current location of the device, wherein the monitoring comprises determining when the current location changes to a visited location that is different from the current location.

The application of an embodiment determines a position of each visited location by generating a first position type of the visited location, wherein the first position type is a relatively low-accuracy position.

The application of an embodiment maintains the visited location in a location list, wherein the location list comprises a plurality of visited locations.

The application of an embodiment identifies any smart location among the plurality of visited locations on the location list, wherein a smart location includes a location visited by the mobile device a number of times, wherein the number of times exceeds a threshold.

The application of an embodiment determines the position of the smart location by generating a second position type of the visited location, wherein the second position type is a relatively high-accuracy position.

The application of an embodiment determines a street address of the smart location.

The identification of any smart location of an embodiment comprises maintaining a mapping of at least one of a day and a time the device is detected at each smart location.

The application of an embodiment generates a prediction table that includes for each smart location at least one probability of the device being at the corresponding smart location.

The prediction table of an embodiment comprises a list days and a plurality of time segments for each day, wherein the prediction table comprises a probability corresponding to each time segment of a plurality of time segments.

Generation of the prediction table of an embodiment comprises identifying for each time segment the smart location having a highest probability.

Generation of the prediction table of an embodiment comprises applying calendar information of the calendar to the prediction table.

Generation of the prediction table of an embodiment comprises modifying the prediction table for each smart location using visit parameters that include at least one of a last day visited, a last time visited, a total number of visits, and consistency data of visits.

Modification of the prediction table of an embodiment comprises revising a first prediction based on at least one of a time and location of a second prediction, wherein a first time segment of the first prediction is adjacent to a second time segment of the second prediction.

The components described herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANS), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory (such as electronically erasable programmable read only memory (EEPROM)), embedded microprocessors, firmware, software, etc. Furthermore, aspects of the systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, HTTPs, FTP, SMTP, WAP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods is not intended to be exhaustive or to limit the systems and methods to the precise forms disclosed. While specific embodiments of and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

The elements and acts of the various embodiments described above can be combined to provide further embodiments. These and other changes can be made to the systems and methods in light of the above detailed description.

What is claimed is:

1. A method provided by an application executing on a processor, the method comprising:
determining a current location of a mobile device hosting the application;
determining using a calendar of the mobile device an event and a start time of the event;
determining a location of the event;
determining a predicted travel time to the location using travel parameters; and
generating and presenting on a display of the mobile device an alert based on the predicted travel time, wherein the alert is an alert for when to start travel to the location.

2. The method of claim 1, comprising:
determining using the calendar a second event and a second start time of the second event, wherein the second event follows the first event;
determining a second location of the second event;
determining a second predicted travel time to the second location using travel parameters; and
generating and presenting on a display of the mobile device a second alert based on the second predicted travel time, wherein the second alert is an alert for when to start travel to the second location.

3. The method of claim 1, comprising launching a navigation application.

4. The method of claim 3, comprising providing to the navigation application the current location and at least one of the first location and the second location.

5. The method of claim 1, wherein the travel parameters include one or more of traffic condition information, travel speed, environment type.

6. The method of claim 1, comprising:
identifying at least one name of a person listed in the event;
retrieving data of the person from at least one of contacts included on the mobile device and a social networking application remote to the mobile device.

7. The method of claim 1, comprising monitoring the current location of the mobile device.

8. The method of claim 7, wherein the monitoring comprises determining when the current location changes to a visited location that is different from the current location.

9. The method of claim 8, comprising determining a position of each visited location by generating a first position type of the visited location.

10. The method of claim 9, wherein the first position type is a relatively low-accuracy position.

11. The method of claim 9, comprising maintaining the visited location in a location list, wherein the location list comprises a plurality of visited locations.

12. The method of claim 11, comprising identifying any smart location among the plurality of visited locations on the location list, wherein a smart location includes a location visited by the mobile device a number of times, wherein the number of times exceeds a threshold.

13. The method of claim 12, comprising determining the position of the smart location by generating a second position type of the visited location.

14. The method of claim 13, wherein the second position type is a relatively high-accuracy position.

15. The method of claim 14, wherein the second position type is a Global Positioning System (GPS) position.

16. The method of claim 14, comprising determining a street address of the smart location.

17. The method of claim 16, comprising determining if the smart location is a designated location, wherein the designated location includes at least one of a home location and a work location.

18. The method of claim 13, comprising:
comparing the plurality of visited locations with calendar information of the calendar;
generating at least one association between at least one visited location of the plurality of visited locations and a term used to identify a calendar event that corresponds to the at least one visited location.

19. The method of claim 12, wherein the identifying of any smart location comprises maintaining a mapping of at least one of a day and a time the mobile device is detected at each smart location.

20. The method of claim 19, comprising generating a prediction table, wherein the prediction table includes for each smart location at least one probability of the mobile device being at the corresponding smart location.

21. The method of claim 20, wherein the prediction table comprises a list days and a plurality of time segments for each day, wherein the prediction table comprises a probability corresponding to each time segment of a plurality of time segments.

22. The method of claim 21, wherein the generating of the prediction table comprises identifying for each time segment the smart location having a highest probability.

23. The method of claim 22, wherein the generating of the prediction table comprises applying calendar information of the calendar to the prediction table.

24. The method of claim 21, wherein the generating of the prediction table comprises modifying the prediction table for each smart location using visit parameters that include at least one of a last day visited, a last time visited, a total number of visits, and consistency data of visits.

25. The method of claim 24, wherein the modifying comprises revising a first prediction based on at least one of a time and location of a second prediction, wherein a first time segment of the first prediction is adjacent to a second time segment of the second prediction.

26. A method provided by an application executing on a processor, the method comprising:
determining a current location of a mobile device hosting the application;
determining using a calendar of the mobile device a plurality of events and a plurality of start times corresponding to the plurality of events;
determining a plurality of locations corresponding to the plurality of events;
determining a plurality of predicted travel times to each of the plurality of locations using travel parameters; and
generating and presenting on a display of the mobile device a plurality of alerts based on the plurality of predicted travel times, wherein an alert is an alert for when to start travel to the location from the current location corresponding to a time of the alert.

27. A system comprising:
an application executing on a processor, the application,
determining a current location of a device hosting the application;
determining using a calendar coupled to the device an event and a start time of the event;
determining a location of the event;
determining a predicted travel time to the location using travel parameters; and
generating and presenting via the device an alert based on the predicted travel time, wherein the alert is an alert for when to start travel to the location.

28. The system of claim 27, wherein the travel parameters include one or more of traffic condition information, travel speed, environment type.

29. The system of claim 27, wherein the application:
identifies at least one name of a person listed in the event;
retrieves data of the person from at least one of contacts included on the device and a social networking application remote to the device.

30. The system of claim 27, wherein the application monitors the current location of the device, wherein the monitoring comprises determining when the current location changes to a visited location that is different from the current location.

31. The system of claim 30, wherein the application determines a position of each visited location by generating a first position type of the visited location, wherein the first position type is a relatively low-accuracy position.

32. The system of claim 31, wherein the application maintains the visited location in a location list, wherein the location list comprises a plurality of visited locations.

33. The system of claim 32, wherein the application identifies any smart location among the plurality of visited locations on the location list, wherein a smart location includes a location visited by the mobile device a number of times, wherein the number of times exceeds a threshold.

34. The system of claim 33, wherein the application determines the position of the smart location by generating a second position type of the visited location, wherein the second position type is a relatively high-accuracy position.

35. The system of claim 34, wherein the application determines a street address of the smart location.

36. The system of claim 33, wherein the identification of any smart location comprises maintaining a mapping of at least one of a day and a time the device is detected at each smart location.

37. The system of claim 36, wherein the application generates a prediction table that includes for each smart location at least one probability of the device being at the corresponding smart location.

38. The system of claim 37, wherein the prediction table comprises a list days and a plurality of time segments for each day, wherein the prediction table comprises a probability corresponding to each time segment of a plurality of time segments.

39. The system of claim 38, wherein generation of the prediction table comprises identifying for each time segment the smart location having a highest probability.

40. The system of claim 39, wherein generation of the prediction table comprises applying calendar information of the calendar to the prediction table.

41. The system of claim 38, wherein generation of the prediction table comprises modifying the prediction table for each smart location using visit parameters that include at least one of a last day visited, a last time visited, a total number of visits, and consistency data of visits.

42. The system of claim 41, wherein modification of the prediction table comprises revising a first prediction based on at least one of a time and location of a second prediction, wherein a first time segment of the first prediction is adjacent to a second time segment of the second prediction.
